(19) United States
(12) Patent Application Publication
(10) Pub. No.: US 2009/0302578 A1
(43) Pub. Date: Dec. 10, 2009

(54) MULTIPLE INTERFACE STROLLER APPARATUS AND SYSTEMS

(75) Inventors: Bryan T. WHITE, Fremont, CA (US); Joseph S. Hei, Palo Alto, CA (US); Colter P. Leys, Menlo Park, CA (US)

Correspondence Address: MORRISON & FOERSTER LLP, 755 PAGE MILL RD, PALO ALTO, CA, 94304-1018, US

(73) Assignee: Orbit Baby, Inc., Newark, CA (US)

(21) Appl. No.: 12/480,546

(22) Filed: Jun. 8, 2009

Related U.S. Application Data
(60) Provisional application No. 61/060,066, filed on Jun. 9, 2008.

(51) Int. Cl. B62B 9/12

(52) U.S. Cl. 280/642; 280/650

(57) ABSTRACT

An apparatus and method for adding an interface to a stroller is described. The apparatus may include a frame supporting a mounting interface for engaging an interface of the stroller, and first and second interfaces, each operable for receiving a removable seating surface. Such an apparatus may be mounted on the interface of a stroller designed to have a single interface for a seat, thereby providing two interfaces for seats. In another example, an apparatus for adding an interface may include an interface for receiving a removable seating surface and a frame operable for attaching to a stroller and supporting the interface. The apparatus may further include an attachment mechanism for attaching to the frame of the stroller and wheels. Such an apparatus may attach to a stroller designed to have a single interface for a seat, thereby introducing at least one more interface for a second seat.

### CROSS REFERENCE TO RELATED APPLICATION

This application claims the benefit of U.S. Provisional Application No. 61/060,066, filed on Jun. 9, 2008, and titled “MULTIPLE INTERFACE STROLLER ATTACHMENT SYSTEMS,” which is incorporated by reference herein in its entirety for all purposes.

### BACKGROUND

1. Field

The present invention relates generally to strollers having an interface for removably securing a seating surface, and in one particular example, to systems and methods for providing additional or multiple interfaces for a stroller.

2. Related Art

Child strollers are well known in the art. Child strollers generally comprise a chassis, wheels, a handle or handles, and seating for at least one child. For example, standard four wheel strollers are generally useful to transport a single child at a walking pace, on a generally smooth terrain, and may be designed to accommodate either an infant or a larger child. Further, double strollers (or other multiple-child strollers) are known. Double strollers generally permit the user to transport two (or more) children in a single stroller. One type of double strollers allows two children to sit one in front of the other, either facing each other or one child behind the other. Such stroller design typically makes them particularly heavy for a single person to lift and adds to the complexity of collapsing the stroller.

Another type of double strollers includes collapsible type strollers with a soft seat, commonly referred to as “umbrella strollers.” While these types of strollers are generally lightweight, easily collapsible and transportable most lack the capability to comfortably carry multiple children. Umbrella strollers which are capable of seating multiple children generally require shared legs and frame members and must be opened or closed as a single unit.

Yet another type of double strollers includes connectors utilized to join at least two strollers together. Although this allows for two separable strollers, removal of the connectors is often cumbersome and these types of devices often have problems with unwanted separating, particularly when the combined strollers are pulled in the reverse direction, thereby making them unwieldy.

Purchasing, storing, and otherwise maintaining both single and double strollers, can present numerous problems. For example, each stroller may be relatively expensive. Moreover, even if a user owns multiple types of strollers, use and/or travel with multiple suitable strollers is often impractical.

### BRIEF SUMMARY

According to one example, an apparatus and method for increasing the number of seating interfaces of a stroller is described. The apparatus may include a frame supporting a mounting interface for engaging a seating interface of the stroller, and first and second interfaces, each operable for receiving a removable seating surface (e.g., a car seat, basinet, booster seat, etc.). Such an apparatus may be mounted on the seating interface of a stroller having a single interface for receiving a seating surface, thereby providing two interfaces each for receiving a seating surface. For example, the apparatus may convert a single interface stroller into a double stroller for receiving and transporting two seats.

The mounting interface may include a hub shaped interface, a bayonet style interface, or other interface for receiving a removable seating surface. Similarly, the first and second interfaces may include hub shaped interfaces, bayonet style interfaces, or the like. The mounting interface may be included on a first side of the frame and the first and second interfaces included on a second opposite side of the frame. Further, the first and second interfaces may be positioned at a common vertical height or dissimilar vertical heights.

In another example, a stroller system is provided. The stroller system may include a stroller having an interface for receiving a removable seating surface and an attachment apparatus having a mounting interface for releasably engaging the interface of the stroller frame and first and second interfaces for receiving a removable seating surface. The stroller system may further include one or two seats that may be releasably attached to either the stroller interface or one of the first and second interfaces of the attachment apparatus.

In another example, an apparatus for adding an interface may include an interface for receiving a removable seating surface, and a frame operable for attaching to a stroller and support the interface. The apparatus may further include an attachment mechanism for releasably attaching to the frame of the stroller and one or more wheels. Such an apparatus may attach to a stroller designed to have a single interface for a seat, thereby introducing at least additional interface for receiving a second seating surface.

Various examples and aspects of the present invention are better understood upon consideration of the detailed description below in conjunction with the accompanying drawings and claims.

### BRIEF DESCRIPTION OF THE DRAWINGS

FIG. 1 illustrates an exemplary stroller having an interface for receiving a seating surface, e.g., a baby seat or bassinet;

FIG. 2A illustrates an exemplary attachment apparatus for engaging the stroller interface and providing two side-by-side interfaces;

FIG. 2B illustrates a lower prospective view of the exemplary attachment apparatus for engaging the stroller interface and providing two side-by-side interfaces;

FIG. 2C illustrates a perspective view of another exemplary attachment apparatus for engaging the stroller interface and providing two side-by-side interfaces;

FIG. 3 illustrates another exemplary attachment apparatus for engaging the stroller interface and providing two interfaces;

FIG. 4 illustrates another exemplary attachment apparatus for use with a stroller to provide an additional interface for a seating surface; and

FIG. 5 illustrates an exemplary stroller and attachment apparatus with seating surfaces mounted thereto.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments. Various modifications to the examples described will be readily apparent to those of ordinary skill in the art, and the general principles defined may be applied to other examples and applications without departing from the spirit and scope of the invention. Thus, the present invention is not intended to be limited to the examples described herein and shown, but is to be accorded a scope consistent with the claims.

Broadly speaking, and in one example, a multiple interface attachment apparatus is described. In some examples, the attachment apparatus engages a stroller's existing interface for receiving a seat and provides two interfaces for engaging seating surfaces (for a net gain of one interface). In other examples the attachment apparatus may include a single interface that is attached to stroller having a first interface to provide a second interface in addition to the first interface.

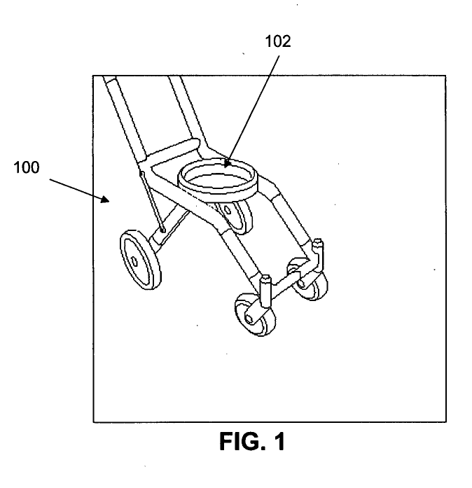

FIG. 1 illustrates an exemplary stroller 100 having an interface 102 for receiving a seating surface, e.g., a car seat, bassinet, booster seat, and so on. For instance, a baby seat may be releasably attached to the stroller 100 through a corresponding or mating interface included with the baby seat. An exemplary stroller system is described and shown in U.S. Pat. No. 7,338,122, entitled “Modular Child Restraint System,” which issued on Mar. 4, 2008, and is hereby incorporated by reference in its entirety. A modular seat system may be used to interchange different types of child seats with a common base or interface, e.g., seats for different stages of child development as well as different uses such as car seats, stroller seats, bassinets, booster seats, rockers, etc. Different seats for different stages of child development may include a rear-facing infant seat, a toddler seat, and a booster seat.

An exemplary modular seat system may include a base and a seat configured to engage the base and to be able to rotate relative to the base when engaged thereto. The base can be configured to attach to a vehicle seat or can be part of a stroller, for example. The seat is configured, in some embodiments, to lock in a position relative to the base. The base can also comprise a visual indicator configured to change color (or otherwise provide a visual cue) in response to the seat being locked in a particular position relative to the base.

As described in the above referenced U.S. Pat. No. 7,338,122, a base interface included with a stroller may include a base hub having a circumferential lip and a plurality of detents. The seat may include a seat hub configured to rotationally engage with the base hub. The seat, in some examples, includes one or more retractable latches configured to engage under the lip to secure the seat hub to the base hub, and lock into the detents to prevent rotation of the seat relative to the base. In other examples, the base may include a base hub having two retaining bars, the seat including a circumferential lip that engages the two retaining bars to secure the seat to the base. The base hub can further include a retractable locking pin configured to engage the seat hub to prevent rotation of the seat hub relative to the base hub.

It will be recognized that the exemplary attachment apparatuses and interfaces described may be used with various other baby strollers and interface configurations. For instance, although the interface shown and described herein is generally a circular or hub-type interface, examples provided are applicable to various other modular or interface systems, whether rotatable or not (such as the commonly known “bayonet” style interfaces including two tongues of plastic that project from the base interface and plug into a suitable interface of the seat, for example). Additionally, exemplary interface apparatuses may be used with other modular type seating systems, e.g., other types of strollers as well as car bases, rockers, and the like. As such, the exemplary circular or hub-type interface is for illustrating a particular type of modular interface, but is not intended to be limiting.

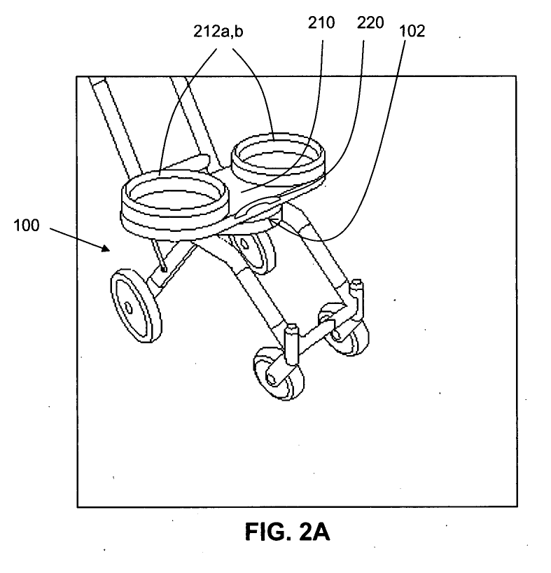

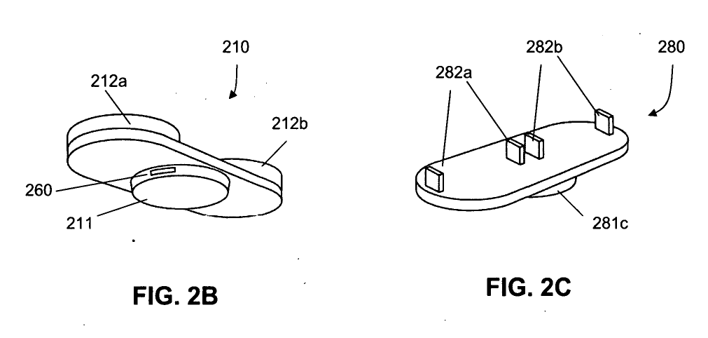

FIG. 2A illustrates an exemplary multi-interface apparatus 210 for engaging the stroller interface 102 and providing two side-by-side interfaces 212a and 212b for receiving a removable seating interface. The attachment apparatus of this example generally includes a platform or frame supporting two female interfaces 212a and 212b for accepting male interfaces of seating surfaces, for example, associated with car seats, stroller seats, bassinet seats, and so on. Further, the attachment apparatus 210 includes a male interface (or mounting interface) on the lower portion thereof for engaging the stroller interface 102, i.e., the female interface of the stroller. The lower interface is similar or identical to the male interface of a seating surface adapted to engage stroller interface 102, and the two upper female interfaces 212a and 212b similar or identical to the stroller interface 102. Therefore, the addition of multi-interface apparatus 210 provides the stroller with a net of one interface for receiving removable seats with the attachment apparatus included.

Additionally, one or more release handles 220 may be included with apparatus 210. A release handle may be used in a similar fashion as for a seat operable with interface 102, e.g., disengaging interface 102 when activated and allowing a user to lift apparatus 210 from stroller 100 and interface 102. In this example, release handle 220 is positioned near longitudinal mid-point, and to the front, of apparatus 210. In other examples, a second release handle (not shown) may be included near a longitudinal mid-point, and to the back of apparatus 210. Of course, it will be understood that release handles may be placed in various configurations and operable to disengage (or engage) a lower interface of apparatus 210 to the stroller interface 102.

It should be noted that other types and configurations of interfaces may be similarly substituted for the generally circular hub-shaped interfaces illustrated in FIG. 2A. For example, apparatus 210 could include common “bayonet” style interfaces on the top portion and a suitable mating portion to the interface of the stroller. Further, different types of interfaces may be included with a common multi-interface apparatus; for example, including a bayonet interface on the bottom for engaging a stroller and circular hub-shaped interfaces on the top.

FIG. 2B illustrates a lower prospective view of the exemplary attachment apparatus 210. In this figure, the lower interface 211 is more clearly seen, and includes at least one latch 260, for engaging with the stroller interface 102 and locking in place therewith. Additionally or alternatively, other locking and engaging mechanism may be used, such as cams, locking pins, detents, circumferential lips or ridges, and so on.

FIG. 2C illustrates a perspective view of another exemplary attachment apparatus 280 for engaging a stroller interface and providing two side-by-side interfaces. In this example, interfaces 282a and 282b include bayonet style interfaces generally comprised of upward extending tongues for engaging with a baby seat. The lower interface 281c may include a female interface in relation to interfaces 282a and 282b for engaging a male interface of a stroller similar to interfaces 282a and 282b. Additionally, lower interface 281c may include a hub type interface as shown in FIG. 2B. Further, an attachment apparatus could combine different types of interfaces, e.g., including interface 212a from FIG. 2B and interface 282b from FIG. 2C with a common apparatus, and further include either of lower interfaces 211 or 281c.

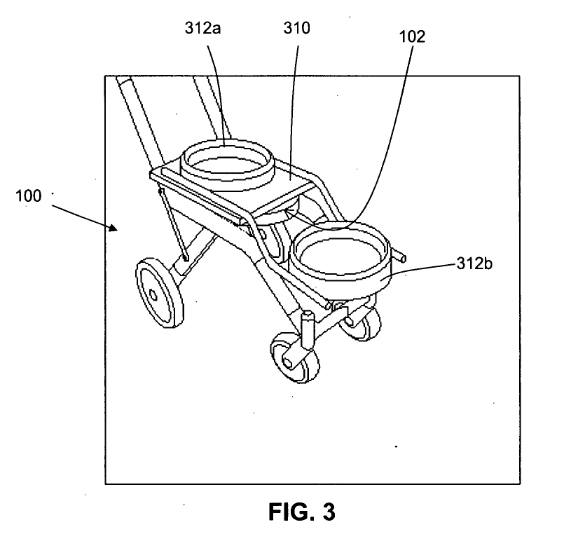

FIG. 3 illustrates another exemplary multi-interface attachment apparatus 310 for engaging stroller interface 102 and providing two in-line interfaces 312a and 312b for receiving a removable seating surface. Multi-interface apparatus 310 of this example is similar to that of FIG. 2, however, in this example the two interfaces 312a and 312b are in-line (e.g., fore aft) and are not at the same vertical height. In other examples, interfaces 312a and 312b can be positioned at the same vertical height (and with respect to FIG. 2, in other examples of the side-by-side interface, the interfaces could be positioned at different heights). Again, the stroller has a net gain of one interface for receiving seats with the attachment apparatus 310 included.

Multi-interface apparatus 310 may further include handles for releasing (or engaging) interface 102 of stroller 100. Additionally, apparatus 310 may include multiple interfaces on the lower portion thereof for engaging stroller 100 and interface 102 in different configurations; for example, in one configuration where interface 312b is lower than interface 312a (as shown) and another configuration where interface 312b is higher than interface 312a.

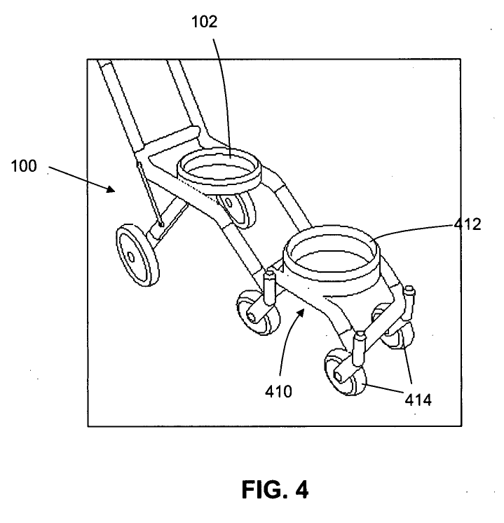

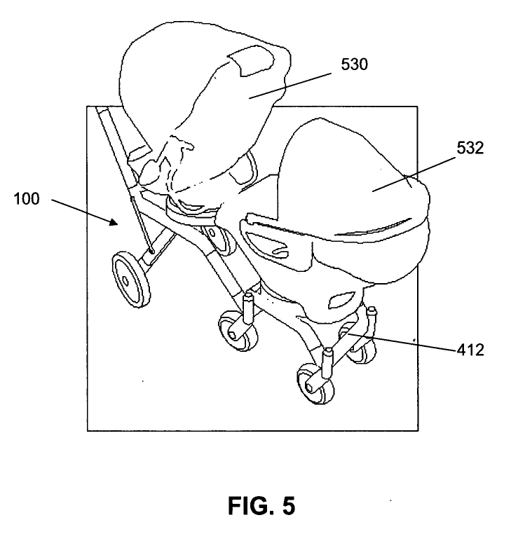

FIG. 4 illustrates another exemplary attachment apparatus 410 for use with a stroller 100 to provide an additional interface for a seating surface and FIG. 5 illustrates the exemplary stroller 100 and attachment apparatus 410 with seating surfaces 530 and 532 mounted thereto. In this example, the attachment apparatus 410 does not engage the stroller interface 102; rather, the apparatus 410 includes a frame for supporting an additional interface 412 and wheels 414. The attachment apparatus 410 can be attached to the stroller 100 via any suitable coupling mechanism; for example, shown here attached via screws at the front of the stroller 100. Additionally, the attachment apparatus 410 could similarly be attached to the rear of the stroller 100 or the side thereof. Further, the attachment apparatus 410 of this example may be used in addition to the attachment apparatus of FIGS. 2 and 3 to provide 3 or more interfaces for receiving seating surfaces.

It should be noted that in other examples, an apparatus similar to that of apparatus 410 could be coupled to stroller 100 without wheels 414. For example, extending from the frame of stroller 102, but not supported by wheels. Further, apparatus 410 could include a single wheel aligned with the center of stroller 100.

The foregoing descriptions of specific embodiments have been presented for purposes of illustration and description. They are not intended to be exhaustive, and it should be understood that many modifications and variations are possible in light of the above teaching. For example, various examples described herein may be used alone or in combination with other systems and methods, and may be modified for varying applications and design considerations. Accordingly, the present invention is defined by the appended claims and should not be limited by the description herein.

We claim:

1. Apparatus for providing an additional seating interface to a stroller, the apparatus comprising:
a frame having:
a mounting interface for engaging an interface of a stroller, and
a first interface and a second interface, each operable for receiving a removable seating surface.

2. The apparatus of claim 1, wherein the mounting interface comprises a hub shaped interface.

3. The apparatus of claim 1, wherein the mounting interface comprises a bayonet style interface.

4. The apparatus of claim 1, wherein the mounting interface is operable to mount to a stroller interface for receiving a baby seat.

5. The apparatus of claim 1, wherein the mounting interface is on a first side of the frame and the first and second interfaces are on a second opposite side of the frame.

6. The apparatus of claim 1, wherein the first and second interfaces are adapted to be positioned at a common vertical height when mounted to a stroller.

7. The apparatus of claim 1, wherein the first and second interfaces are adapted to be positioned at different vertical heights when mounted to a stroller.

8. The apparatus of claim 1, wherein the first and second interfaces comprise hub shaped interfaces.

9. The apparatus of claim 1, wherein the first and second interfaces comprise bayonet style interfaces.

10. A stroller system comprising
a stroller having an interface for receiving a removable seating surface; and
an attachment apparatus having:
a mounting interface for releasably engaging the interface of the stroller frame, and
a first interface and a second interface, each operable for receiving a removable seating surface.

11. The stroller system of claim 10, further comprising at least one seating surface operable to engage the first interface.

12. The stroller system of claim 10, further comprising at least one seating surface operable to separately engage both the interface of the stroller and the first interface.

13. The stroller system of claim 10, wherein the interface of the stroller is a hub shaped interface.

14. The stroller system of claim 10, wherein the interface of the stroller is a bayonet interface.

15. Apparatus for adding an interface to a stroller, the apparatus comprising:
an interface for receiving a removable seating surface; and
a frame operable for attaching to a stroller and supporting the interface.

16. The apparatus of claim 15, wherein the frame comprises at least one wheel.

17. The apparatus of claim 15, wherein the interface comprises a hub shaped interface.

18. The apparatus of claim 15, wherein the interface comprises a bayonet style interface.
